(19) United States
(12) Patent Application Publication
(10) Pub. No.: US 2025/0092205 A1
(43) Pub. Date: Mar. 20, 2025

(54) HEAT-SHRINKABLE POLYESTER FILM

(71) Applicants: C.I. TAKIRON Corporation, Osaka (JP); Bonset America Corporation, Browns Summit, NC (US)

(72) Inventors: Takuma KANEKO, Osaka (JP); Yuichiro KANZAKA, Osaka (JP); Shuuta YUGE, Osaka (JP); Tatsuya IRIFUNE, Osaka (JP)

(21) Appl. No.: 18/725,948

(22) PCT Filed: Sep. 28, 2022
(86) PCT No.: PCT/JP2022/036184

§ 371 Date: Jul. 1, 2024

(30) Foreign Application Priority Data
Mar. 31, 2022 (JP) 2022-059424

(51) Int. Cl. C08J 5/18; B32B 27/08; B32B 27/36

(52) U.S. Cl. CPC C08J 5/18; B32B 27/08; B32B 27/36; B32B 2307/704; B32B 2307/736; B32B 2439/60; C08J 2367/00

(57) ABSTRACT

A heat-shrinkable polyester film having excellent wrinkle resistance is provided.

A heat-shrinkable polyester film derived from a polyester resin composition including a crystalline polyester resin of 10% to 50% by weight, satisfies the following configurations (a) to (d):
(a) (b) when thermal shrinkage ratios (TD direction at 70° C. for 10 seconds) measured before and after the film is left to stand under predetermined conditions are designated as A1(%) and A2(%), A1 has a value of 0% to 20%, A2 has a value of 0% to 24%, and A2-A1 has a value of −4% to 4%; and
(c) (d) a thermal shrinkage ratio A3 (TD direction at 80° C. for 10 seconds) has a value of 30% or more, and a thermal shrinkage ratio B (MD direction at 90° C. for 10 seconds) has a value of 10% or less.

### TECHNICAL FIELD

The present invention relates to a heat-shrinkable polyester film (hereinafter, sometimes called as a polyester-based shrink film, or simply as a shrink film).

More particularly, the present invention relates to a heat-shrinkable polyester film that has little variation in the thermal shrinkage ratio at a predetermined temperature even after the heat-shrinkable polyester film is left to stand under high-humidity conditions and under the conditions of a predetermined time, and has excellent wrinkle resistance.

### BACKGROUND ART

Conventionally, shrink films have been widely used as base films for labels of PET bottles and the like. Particularly, it is the current situation that heat-shrinkable polyester films are increasing their market share as base films for labels due to their excellent strength, transparency, and the like.

Although a heat-shrinkable polyester film has such excellent characteristics, since a heat-shrinkable polyester film exhibits rapid thermal response when heated, a situation in which the film shrinks non-uniformly, and wrinkles easily occur, can be seen.

That is, a heat-shrinkable polyester film is affected by the storage conditions for shrink films, particularly humidity and the like, so that the thermal shrinkage ratio at a predetermined temperature varies, and furthermore, there is observed a problem that wrinkles easily occur when a shrink label is thermally shrunk.

Thus, in order to prevent the occurrence of wrinkles in labels, various heat-shrinkable polyester films suitable for use in labels, which have high thermal shrinkage ratios in the width direction while having low thermal shrinkage ratios in the longitudinal direction, have high mechanical strength in the longitudinal direction, and have satisfactory perforation opening property and excellent shrink finish property, have been proposed (see, for example, Patent Document 1).

More specifically, a biaxially stretched heat-shrinkable polyester film satisfying the following configuration requirements (1) to (6) is available.
(1) 1,4-cyclohexanedimethanol is used as an amorphous monomer in an amount in a range of 5 mol % or more and 30 mol % or less in 100 mol % of the alcohol component.
(2) The hot water thermal shrinkage ratio obtained when the film is immersed in hot water at 98° C. for 10 seconds is 60% or more and 90% or less in the main shrinkage direction of the film.
(3) The hot water thermal shrinkage ratio obtained when the film is immersed in hot water at 98° C. for 10 seconds is-5% or more and 5% or less in a direction orthogonally intersecting the main shrinkage direction of the film.
(4) The right-angle tear strength per unit thickness in the direction orthogonally intersecting the main shrinkage direction after shrinking the film by 10% in the main shrinkage direction in hot water at 80° C. is 180 N/mm or more and 350 N/mm or less.
(5) The maximum shrinkage stress in the main shrinkage direction of the film measured with hot air at 90° C. is 2 MPa or more and 10 MPa or less, and the shrinkage stress after 30 seconds from the start of measurement is 60% or more and 100% or less of the maximum shrinkage stress.
(6) The difference between the hot water thermal shrinkage ratios in the main shrinkage direction at 70° C. measured before and after an aging treatment at a temperature of 30° C., a humidity of 65% RH for 672 hours, is 10% or less.

### CITATION LIST

### Patent Document

Patent Document 1: JP 2019-81378 A (claims and the like)

### DISCLOSURE OF THE INVENTION

### Problem to be Solved by the Invention

However, in the case of the heat-shrinkable polyester film disclosed in Patent Document 1, no consideration has been given to an attempt at blending a predetermined amount of a crystalline polyester resin to produce a heat-shrinkable polyester film and controlling the hygroscopic property and the like in order to reduce variation in the physical properties such as thermal shrinkage ratios.

Furthermore, in the case of such a heat-shrinkable polyester film, an aging treatment is performed under the conditions of 30° C. or lower and 65% RH for 672 hours, and the difference between the hot water thermal shrinkage ratios in the main shrinkage direction at 70° C. measured before and after the aging treatment is controlled to a value of 10% or less; however, since hygroscopic property is not taken into consideration, in reality, stable control of the thermal shrinkage ratio is difficult.

Therefore, the heat-shrinkable polyester film disclosed in Patent Document 1 frequently has a problem that when the heat-shrinkable polyester film is wrapped around a PET bottle as a shrink label and is shrunk, wrinkles easily occur.

Thus, the inventors of the present invention made extensive efforts in view of the above-described problems, and as a result, the inventors solved the problems in the related art by providing a heat-shrinkable polyester film derived from a polyester resin composition including a predetermined amount of a crystalline polyester resin, which has at least predetermined configurations (a) to (d).

That is, it is an object of the present invention to provide a heat-shrinkable polyester film that controls hygroscopic property before and after being left to stand for 24 hours under high humidity conditions (60% RH) as simple aging, is stably thermally shrunk to a desired value when being thermally shrunk under predetermined conditions, and also has an excellent wrinkle resistance characteristic.

### Means for Solving Problem

According to the present invention, there is provided a heat-shrinkable polyester film derived from a polyester resin composition including a crystalline polyester resin in an amount in a range of 10% to 50% by weight with respect to a total resin amount, in which when a main shrinkage direction is designated as TD direction, and a direction orthogonally intersecting the TD direction is designated as MD direction, the heat-shrinkable polyester film satisfies the following configurations (a) to (d), and the above-mentioned problems can be solved.
(a) When thermal shrinkage ratios obtained in a case where the heat-shrinkable polyester film is shrunk in the TD direction under the conditions of 10 seconds in hot water at 70° C. before and after being left to stand for 24 hours under high humidity conditions at 20° C. and 90% RH, are designated as A1(%) and A2(%), respectively, the thermal shrinkage ratio A1 has a value within a range of 0% to 20%, and the thermal shrinkage ratio A2 has a value within a range of 0% to 24%.
(b) A numerical value represented by A2-A1, which is a difference between the thermal shrinkage ratio A1 and the thermal shrinkage ratio A2, has a value within a range of −4% to 4%.
(c) When a thermal shrinkage ratio obtained in a case where the heat-shrinkable polyester film is shrunk in the TD direction under the conditions of 10 seconds in hot water at 80° C. is designated as A3, the A3 has a value of 30% or more.
(d) When a thermal shrinkage ratio obtained in a case where the heat-shrinkable polyester film is shrunk in the MD direction under the conditions of 10 seconds in hot water at 90° C. is designated as B, the B has a value of 10% or less.

That is, a heat-shrinkable polyester film derived from a polyester resin composition including a crystalline polyester resin in an amount in a range of 10% to 50% by weight with respect to the total resin amount, the heat-shrinkable polyester film having little change in the physical properties such as the thermal shrinkage ratio even when subjected to simple aging for about 24 to 48 hours under high humidity conditions at 30° C. or lower and at about 90% RH, can be provided in a case where the heat-shrinkable polyester film satisfies all of the configurations (a) to (d).

Therefore, when the shrink film is applied to a PET bottle or the like, a desired thermal shrinkage ratio in the TD direction or MD direction is stably obtained at each shrinkage temperature, and accordingly, satisfactory wrinkle resistance characteristics can be obtained.

The wrinkle resistance characteristics can be determined, for example, according to the evaluation criteria in Evaluation 7 of Example 1.

Furthermore, upon configuring the heat-shrinkable polyester film of the present invention, when a thermal shrinkage ratio obtained in a case where the heat-shrinkable polyester film is shrunk in the TD direction under the conditions of 10 seconds in hot water at 80° C. after being left to stand for 24 hours under high humidity conditions at 20° C. and 90% RH, is designated as A4(%), it is preferable that a numerical value represented by A4-A3 has a value of 3% or less.

By specifically limiting the numerical value represented by A4-A3 to be within a predetermined range in this way, the numerical value represented by A2-A1 can also be easily controlled, and the wrinkle resistance characteristics can be further improved.

A3 is the thermal shrinkage ratio corresponding to the above-described configuration (c).

Furthermore, upon configuring the heat-shrinkable polyester film of the present invention, it is preferable that the thermal shrinkage ratio A4 obtained when the heat-shrinkable polyester film is shrunk under the conditions of 10 seconds in hot water at 80° C. has a value in a range of 30% to 70%.

By specifically limiting the thermal shrinkage ratio A4 to a value within a predetermined range in this way, the numerical value represented by A4-A3 is also more easily controlled to be within a predetermined range.

Furthermore, upon configuring the heat-shrinkable polyester film of the present invention, when moisture percentages measured according to JIS K 0113:2005 before and after the heat-shrinkable polyester film is left to stand for 24 hours under high humidity conditions at 20° C. and 90% RH are designated as W1 (ppm) and W2 (ppm), respectively, it is preferable that a numerical value represented by W2−W1 has a value of 2500 ppm or less.

By limiting the value of W2−W1 to be equal to or less than a predetermined value in this way, the hygroscopic property under predetermined high humidity conditions can be suppressed, and the wrinkle resistance characteristics can be further improved.

Furthermore, upon configuring the heat-shrinkable polyester film of the present invention, it is preferable that the moisture percentage W1 has a value within a range of 2000 to 3500 ppm, and the moisture percentage W2 has a value within a range of 4000 to 5500 ppm.

By specifically limiting the moisture percentages W1 and W2 to values within predetermined ranges in this way, the numerical value represented by W2−W1 can be more easily controlled within a predetermined range.

Furthermore, upon configuring the heat-shrinkable polyester film of the present invention, it is preferable that the maximum shrinkage stress at a shrinkage temperature of 85° C. in the TD direction is designated as C, and this C has a value of 12 MPa or less.

In this way, by controlling the maximum shrinkage stress to be equal to or less than a predetermined value, wrinkles occurring due to excess maximum shrinkage stress at the time of thermal shrinkage can be effectively suppressed.

Furthermore, upon configuring the heat-shrinkable polyester film of the present invention, it is preferable that b* in the chromaticity coordinates of CIE 1976 L*a*b* (hereinafter, may be simply referred to as CIE chromaticity coordinates) as measured according to JIS Z 8781-4:2013, has a value within a range of 0.15 to 0.3.

By limiting b* in the chromaticity coordinates to a value within a predetermined range in this way, the blending amount of the crystalline polyester resin and the like in the heat-shrinkable polyester film can be controlled more accurately, though indirectly, to a desired range.

Furthermore, upon configuring the heat-shrinkable polyester film of the present invention, it is preferable that the haze value of the film before thermal shrinkage measured according to JIS K 7136:2000 has a value of 8% or less.

By specifically limiting the haze value to be equal to or less than a predetermined value in this way, the transparency of the heat-shrinkable polyester film is more easily controlled quantitatively, and since the transparency is satisfactory, versatility can be further enhanced.

### BRIEF DESCRIPTION OF DRAWINGS

FIGS. 1A to 1C are each a diagram for describing a form of a heat-shrinkable polyester film;

FIG. 2A is a diagram for describing the relationship between the blending amount of a crystalline polyester resin in the heat-shrinkable polyester film and the value of b* in the CIE chromaticity coordinates, and FIG. 2B is a diagram for describing the relationship between the blending amount of the crystalline polyester resin in the heat-shrinkable polyester film and the difference between the thermal shrinkage ratios (A2−A1) under predetermined heating conditions (hot water at 70° C. for 10 seconds) of the heat-shrinkable polyester film measured before and after an aging treatment;

FIGS. 3A and 3B are diagrams for describing the relationship between the thermal shrinkage ratios (A1 and A2) under predetermined heating conditions (hot water at 70° C. for 10 seconds) of the heat-shrinkable polyester film measured before and after an aging treatment under predetermined high humidity conditions and the ratings (relative values) of wrinkle resistance characteristics;

FIG. 4 is a diagram for describing the relationship between the thermal shrinkage ratio (A1) under predetermined heating conditions (hot water at 70° C. for 10 seconds) of the heat-shrinkable polyester film before the aging treatment and the difference between predetermined thermal shrinkage ratios (A2−A1);

FIG. 5 is a diagram for describing the relationship between the thermal shrinkage ratio (A2) under predetermined heating conditions (hot water at 70° C. for 10 seconds) of the heat-shrinkable polyester film after the aging treatment and the difference between predetermined thermal shrinkage ratios (A2−A1);

FIG. 6 is a diagram for describing the relationship between the difference (A2−A1) between predetermined thermal shrinkage ratios and the ratings (relative value) of the wrinkle resistance characteristics;

FIG. 7A is a diagram (photograph) showing the appearance state of a tubular-shaped label corresponding to Example 1 in a case where wrinkles do not occur, and FIGS. 7B to 7D are enlarged views showing regions P, Q, and R, respectively, of the appearance shown in FIG. 7A;

FIG. 8A is a diagram (photograph) showing the appearance state of a tubular-shaped label corresponding to Comparative Example 1 in a case where wrinkles have occurred, and FIGS. 8B to 8D are enlarged views showing regions S, T, and U, respectively, of the appearance shown in FIG. 8A; and

FIG. 9 is a diagram for describing the relationship between the difference (W2−W1) between the moisture percentages of the heat-shrinkable polyester film obtained before and after an aging treatment, and the difference (A2−A1) between predetermined thermal shrinkage ratios.

### BEST MODES FOR CARRYING OUT THE INVENTION

### First Embodiment

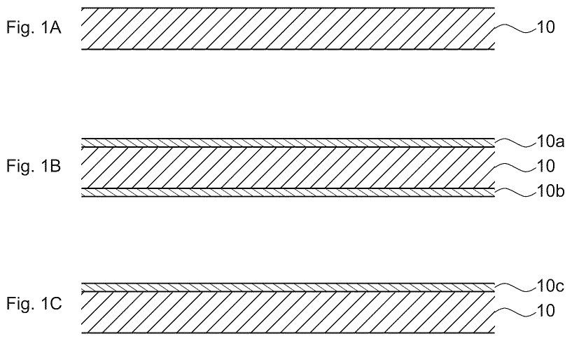

A first embodiment is, as illustrated in FIGS. 1A to 1C, a heat-shrinkable polyester film 10 derived from a polyester resin composition including a crystalline polyester resin in an amount in a range of 10% to 50% by weight with respect to the total resin amount, in which when a main shrinkage direction is designated as TD direction, and a direction orthogonally intersecting the TD direction is designated as MD direction, the heat-shrinkable polyester film satisfies the following configurations (a) to (d).
(a) When thermal shrinkage ratios obtained in a case where the heat-shrinkable polyester film is shrunk in the TD direction under the conditions of 10 seconds in hot water at 70° C. before and after being left to stand for 24 hours under high humidity conditions at 20° C. and 90% RH, are designated as A1(%) and A2(%), respectively, the thermal shrinkage ratio A1 has a value within a range of 0% to 20%, and the thermal shrinkage ratio A2 has a value within a range of 0% to 24%.
(b) A numerical value represented by A2−A1, which is a difference between the thermal shrinkage ratio A1 and the thermal shrinkage ratio A2, has a value within a range of −4% to 4%.
(c) When a thermal shrinkage ratio obtained in a case where the heat-shrinkable polyester film is shrunk in the TD direction under the conditions of 10 seconds in hot water at 80° C. is designated as A3, this A3 has a value of 30% or more.
(d) When a thermal shrinkage ratio obtained in a case where the heat-shrinkable polyester film is shrunk in the MD direction under the conditions of 10 seconds in hot water at 90° C. is designated as B, this B has a value of 10% or less.

Hereinafter, various parameters and the like will be specifically described by dividing the configuration of the heat-shrinkable polyester film of the first embodiment, with appropriate reference to the drawings.

### 1. Polyester Resin

Regarding a polyester resin, which is a main component, the type thereof is basically not limited as long as it is a polyester resin that is likely to satisfy the above-mentioned configurations of (a) to (d); however, usually, it is preferable that the polyester resin is a polyester resin composed of a diol and a dicarboxylic acid, a polyester resin composed of a diol and a hydroxycarboxylic acid, a polyester resin composed of a diol, a dicarboxylic acid, and a hydroxycarboxylic acid, or a mixture of these polyester resins.

Here, the diol as a raw material component of the polyester resin may be at least one of aliphatic diols such as ethylene glycol, diethylene glycol, propanediol, butanediol, neopentyl glycol, and hexanediol; alicyclic diols such as 1, 4-hexanedimethanol; and aromatic diols.

Among these, ethylene glycol, diethylene glycol, and 1, 4-hexanedimethanol are particularly preferred.

The dicarboxylic acid as a compound component of the same polyester resin may be at least one of fatty acid dicarboxylic acids such as adipic acid, sebacic acid, and azelaic acid; aromatic dicarboxylic acids such as terephthalic acid, naphthalenedicarboxylic acid, and isophthalic acid; alicyclic dicarboxylic acids such as 1,4-cyclohexanedicarboxylic acid; or ester-forming derivatives of these.

Among these, terephthalic acid is particularly preferred.

The hydroxycarboxylic acid as a compound component of the same polyester resin may be at least one of lactic acid, hydroxybutyric acid, and polycaprolactone.

As a non-crystalline polyester resin, for example, a non-crystalline polyester resin composed of dicarboxylic acids including at least 80 mol % of terephthalic acid, and diols composed of 50 mol % to 80 mol % of ethylene glycol and 20 mol % to 50 mol % of one or more selected from 1,4-cyclohexanedimethanol, neopentyl glycol, and diethylene glycol, can be suitably used.

In order to change the property of the film as needed, other dicarboxylic acids and diols or hydroxycarboxylic acids may also be used. Each of these components may be used singly or as a mixture.

On the other hand, examples of the crystalline polyester resin include polyethylene terephthalate, polyethylene naphthalate, polybutylene terephthalate, polybutylene naphthalate, and polypropylene terephthalate, and each of these may be used singly or as a mixture.

Furthermore, when the polyester resin is a mixture of a crystalline polyester resin and a non-crystalline polyester resin, in order to obtain satisfactory and appropriate wrinkle resistance characteristics, heat resistance, thermal shrinkage ratio, and the like, it is preferable that the blending amount of the crystalline polyester resin has a value within a range of 10% to 50% by weight with respect to the total amount (100% by weight) of the resins constituting the heat-shrinkable polyester film.

The reason for this is that by adjusting the blending amount of the crystalline polyester resin to a value within a predetermined range in this way, a heat-shrinkable polyester film that exhibits satisfactory thermal shrinkage characteristics and has little change in the thermal shrinkage ratio at a predetermined temperature as a physical property even under high humidity conditions, can be obtained.

More specifically, it is because when the content of the crystalline polyester resin has a value of less than 10% by weight, it may be difficult to suppress hygroscopic property when the heat-shrinkable polyester film is left to stand for a relatively short period of time in a predetermined high humidity environment, and it may not be possible to control a numerical value represented by A2-A1, which is the difference between predetermined thermal shrinkage ratios, to be within a predetermined range.

On the other hand, it is because when the content of the crystalline polyester resin is more than 50% by weight, the shrinkage ratio of the heat-shrinkable polyester film may be excessively decreased.

Therefore, it is more preferable that the blending amount of the crystalline polyester resin has a value within a range of 15% to 45% by weight, and even more preferably a value within a range of 20% to 40% by weight, with respect to the total amount (100% by weight) of resins.

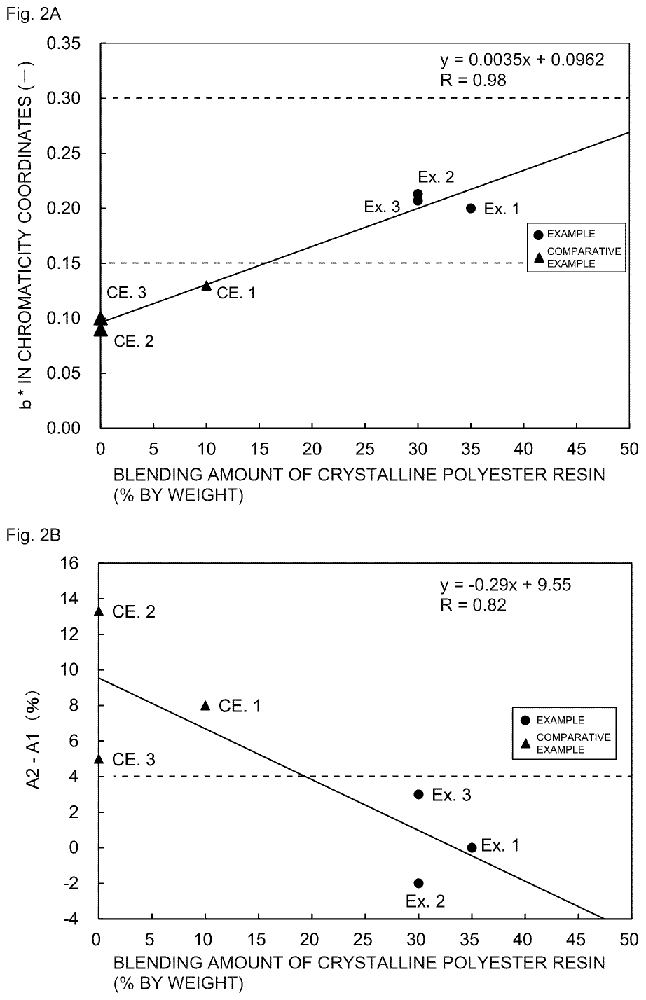

Here, referring to FIG. 2A, the relationship between the blending amount of the crystalline polyester resin in the heat-shrinkable polyester film and b* in the chromaticity coordinates of CIE 1976 L*a*b* (hereinafter, may be simply referred to as CIE chromaticity coordinates) as measured according to JIS Z 8781-4:2013 will be described.

That is, the axis of abscissa in FIG. 2A represents, for example, the blending amount (% by weight) of the crystalline polyester resin in a heat-shrinkable polyester film having a thickness of 30 μm, and the axis of ordinate represents b* (−) in the CIE chromaticity coordinates.

In the diagram, Example 1 is described as Ex. 1, while Comparative Example 1 is described as CE. 1, and the same applies hereinafter.

From the characteristic curve in FIG. 2A, it is understood that there is an excellent correlation (correlation coefficient (R) is 0.98) in the relationship between the blending amount of such a crystalline polyester resin and the value of b* in the chromaticity coordinates.

Therefore, it can be said that by limiting the blending amount of the crystalline polyester resin, the value of b* in the chromaticity coordinates is also easily controlled to be within a predetermined range.

Conversely, by limiting b* in the chromaticity coordinates to a value within a predetermined range (0.15 to 0.3), the blending amount of the crystalline polyester resin and the like in the heat-shrinkable polyester film can be controlled more accurately, though indirectly.

Furthermore, referring to FIG. 2B, the relationship between the blending amount of the crystalline polyester resin in the heat-shrinkable polyester film and the difference between the thermal shrinkage ratios (A2−A1) under predetermined heating conditions (hot water at 70° C. for 10 seconds) of the heat-shrinkable polyester film measured before and after an aging treatment under predetermined high humidity conditions, will be described.

That is, the axis of abscissa in FIG. 2B represents the blending amount (% by weight) of the crystalline polyester resin, and the axis of ordinate represents the value of A2−A1(%), which is the difference between predetermined thermal shrinkage ratios.

From the characteristic curve in FIG. 2B, it is understood that there is an excellent correlation (correlation coefficient (R) is 0.82) in the relationship between the blending amount of the crystalline polyester resin and the numerical value represented by A2−A1.

Therefore, it can be said that by limiting the blending amount of the crystalline polyester resin, the numerical value represented by A2−A1 is easily controlled to be within a predetermined range.

### 2. Configuration (a)

Configuration (a) is a necessary configuration requirement to the effect that when the thermal shrinkage ratios in the TD direction obtained in a case where the heat-shrinkable polyester film is shrunk under the conditions of 10 seconds in hot water at 70° C., as measured before and after being left to stand for 24 hours under high humidity conditions at 20° C. and 90% RH as aging conditions, are designated as A1(%) and A2(%), respectively, the thermal shrinkage ratio A1 has a value within a range of 0% to 20%, and the thermal shrinkage ratio A2 has a value within a range of 0% to 24%.

The reason for this is that changes in the physical properties associated with moisture absorption occurring when the heat-shrinkable polyester film is left to stand for a relatively short period of time under predetermined high humidity conditions, are suppressed, and the wrinkle resistance characteristics are improved in cooperation with satisfying other configurations (b) and the like.

More specifically, it is because when the thermal shrinkage ratio A1 of such a film has a value of more than 20%, it is difficult to limit the predetermined numerical value represented by A2−A1 as will be described below to a value within a predetermined range, and it may not be possible to suppress changes in the physical properties associated with moisture absorption when the film is left to stand for a relatively short period of time under high humidity conditions.

However, when the thermal shrinkage ratio A1 of the film is excessively small, the thermal shrinkage ratio at 80° C. to 100° C. may be insufficient, the film may not be able to follow the shape of a PET bottle when wrapped around the bottle, and it may not be possible to suppress the occurrence of wrinkles.

Therefore, it is more preferable that the thermal shrinkage ratio A1 of the film has a value within a range of 2% to 19%, and even more preferably a value within a range of 3% to 18%.

On the other hand, it is because when the thermal shrinkage ratio A2 of the above-mentioned film has a value of more than 24%, similarly to the case of A1, it is difficult to limit the numerical value represented by A2−A1 to be within a predetermined range, and it may not be possible to suppress changes in the physical properties associated with moisture absorption when the film is left to stand for a relatively short period of time under high humidity conditions.

However, even for the thermal shrinkage ratio A2 of such a film, when the value thereof is excessively small, the thermal shrinkage ratio at 80° C. to 100° C. may be insufficient, the heat-shrinkable polyester film may not be able to follow the shape of a PET bottle when wrapped around the bottle, and it may not be possible to suppress the occurrence of wrinkles.

Therefore, it is more preferable that the thermal shrinkage ratio A2 of the film has a value within a range of 2% to 22%, and even more preferably a value within a range of 3% to 20%.

The thermal shrinkage ratio of a shrink film is defined by the following formula.

$$Thermal shrinkage ratio ( \% ) = ( {L}_{0} - {L}_{1} ) / {L}_{0} \times 100$$

L₀: Dimension (longitudinal direction or width direction) of a sample before heat treatment
L₁: Dimension (same direction as L₀) of the sample after heat treatment

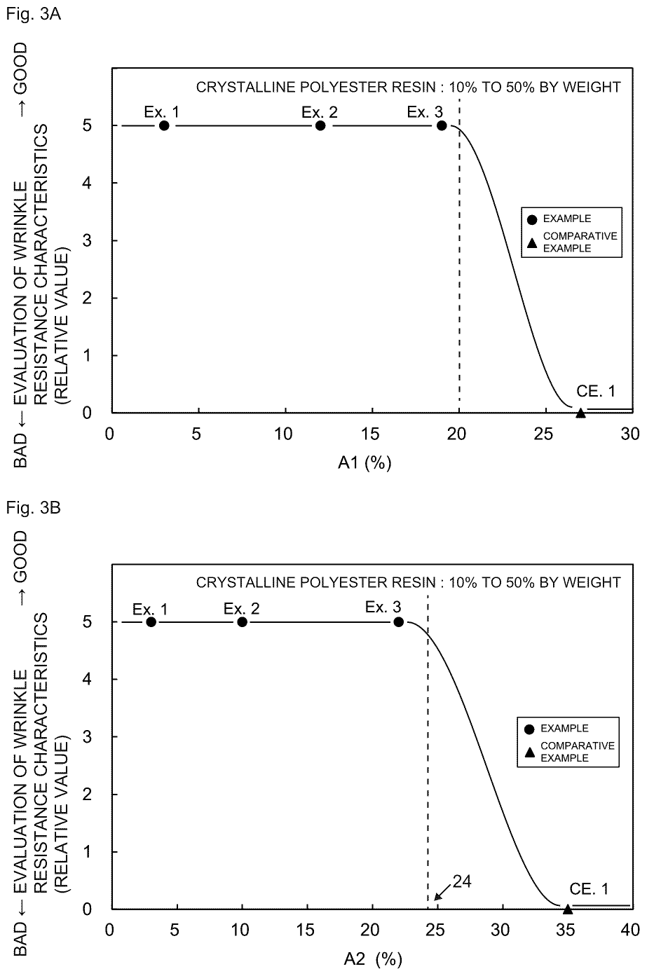

Here, referring to FIGS. 3A and 3B, the relationship between each of the thermal shrinkage ratios A1(%) and A2(%) and the wrinkle resistance characteristics (relative values in evaluation) will be described.

That is, the axis of abscissa in FIG. 3A represents the thermal shrinkage ratio A1(%), and the axis of ordinate represents the rating (relative value) of the wrinkle resistance characteristic.

The ratings (relative value) of the wrinkle resistance characteristics on the axis of ordinate are numerically expressed such that the rating ⊙ is 5 points, the rating ◯ is 3 points, the rating Δ is 1 point, and the rating x is 0 points.

Furthermore, the axis of abscissa in FIG. 3B represents the thermal shrinkage ratio A2(%), and the axis of ordinate represents the rating (relative value) of the wrinkle resistance characteristic, similarly to the case of FIG. 3A.

Each characteristic curve in FIGS. 3A and 3B is based on the evaluation results for the wrinkle resistance characteristics of the heat-shrinkable polyester films of Examples 1 to 3 and Comparative Example 1 including a predetermined amount of a crystalline polyester resin as will be described below.

From such characteristic curves, it is understood that there is a predetermined relationship between each of the thermal shrinkage ratios A1(%) and A2(%) and the wrinkle resistance characteristic.

More specifically, from the characteristic curve in FIG. 3A, for example, when the thermal shrinkage ratio A1 is limited to be 20% or less, a satisfactory result of at least 4 or more is obtained for the rating (relative value) of the wrinkle resistance characteristic.

Similarly, from the characteristic curve in FIG. 3B, for example, when the thermal shrinkage ratio A2 is limited to be 24% or less, a satisfactory result of at least 4 or more is obtained for the rating (relative value) of the wrinkle resistance characteristic.

### 3. Configuration (b)

Configuration (b) is a necessary configuration requirement to the effect that a numerical value represented by A2−A1, which is the difference between the thermal shrinkage ratio A1 and the thermal shrinkage ratio A2 measured under predetermined conditions before and after an aging treatment under predetermined high humidity conditions, has a value within a range of −4% to 4%.

The reason for this is that by controlling the value of A2−A1 in this way, when combined with the configuration (a) or the like, hygroscopic property can be suppressed even under predetermined high humidity conditions. Therefore, by satisfying other configurations (c) and (d), there is little change in the thermal shrinkage ratios and the like at a predetermined temperature, the heat-shrinkable polyester film can be thermally shrunk stably with satisfactory reproducibility under predetermined conditions, while on the other hand, excellent wrinkle resistance characteristics can be exhibited.

More specifically, it is because when the numerical value represented by A2−A1 deviates from the above-mentioned predetermined range, it is difficult to suppress hygroscopic property under predetermined high humidity conditions, so that when the thermal shrinkage temperature is 80° C. to 100° C., the thermal shrinkage ratio in the main shrinkage direction may greatly change during a process in which the thermal shrinkage temperature of the film increases (for example, 70° C. to 80° C.), and the wrinkle resistance characteristics may be markedly decreased.

Furthermore, when the control of the numerical value represented by A2−A1 is difficult, there is large change in the thermal shrinkage ratio and the like at a predetermined temperature, and the setting conditions for the heating shrinkage facilities used when the heat-shrinkable polyester film is wrapped around various PET bottles may require extensive changes.

Therefore, it is more preferable that the numerical value represented by A2−A1 as the configuration (b) has a value within a range of −3% to 3%, and even more preferably a value within a range of −2% to 2%.

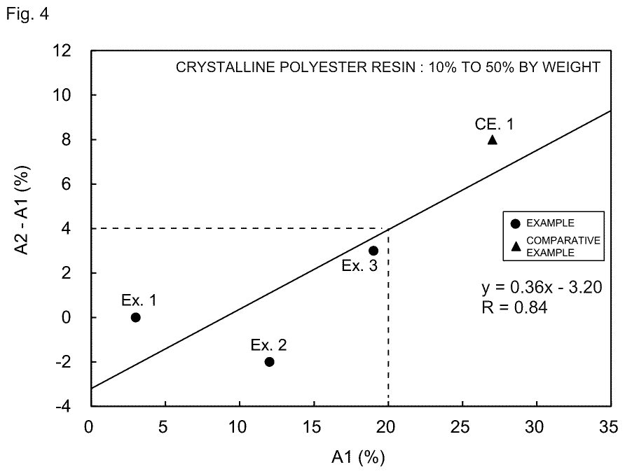

Here, referring to FIG. 4, the relationship between the thermal shrinkage ratio (A1) of the heat-shrinkable polyester film under predetermined heating conditions (hot water at 70° C. for 10 seconds) before an aging treatment under predetermined high humidity conditions (left to stand at 20° C. and 90% RH for 24 hours), and the difference between the thermal shrinkage ratios (A2−A1) under predetermined heating conditions (hot water at 70° C. for 10 seconds) of the heat-shrinkable polyester film measured before and after such an aging treatment, will be described.

That is, the axis of abscissa in FIG. 4 represents A1(%), and the axis of ordinate represents the value of A2−A1(%).

As will be described below, the characteristic curve in FIG. 4 is based on the evaluation results of A1 and the numerical value represented by A2−A1 for the heat-shrinkable polyester films of Examples 1 to 3 and Comparative Example 1 including a predetermined amount of a crystalline polyester resin.

From such a characteristic curve, it is understood that the relationship between A1 and the value of A2−A1 has an excellent correlation (correlation coefficient (R) is 0.84).

Therefore, it can be said that the value of A2−A1 can also be accurately controlled to be within a predetermined range by limiting A1 to a value within a predetermined range.

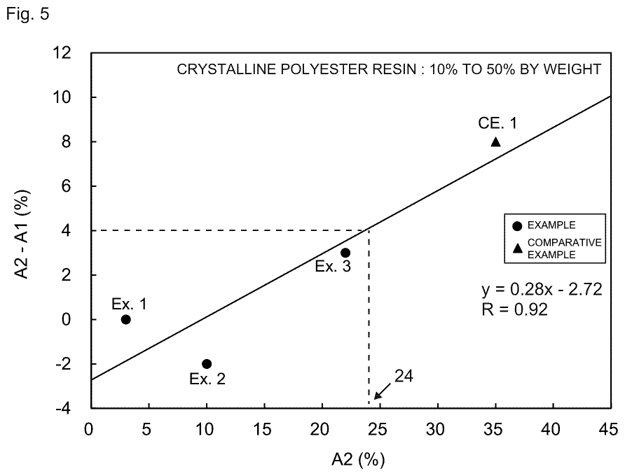

Next, referring to FIG. 5, the relationship between the thermal shrinkage ratio (A2) under predetermined heating conditions (hot water at 70° C. for 10 seconds) of the heat-shrinkable polyester film after an aging treatment and the difference between the above-mentioned heat shrinkage ratios (A2−A1), will be described.

That is, the axis of abscissa represents A2(%), and the axis of ordinate represents the value of A2−A1(%).

As will be described below, the characteristic curve in FIG. 5 is based on the evaluation results of the numerical value represented by A2 and the value of A2−A1 for the heat-shrinkable polyester films of Examples 1 to 3 and Comparative Example 1 including a predetermined amount of a crystalline polyester resin.

From such a characteristic curve, it is understood that the relationship between A2 and the value of A2−A1 has an excellent correlation (correlation coefficient (R) is 0.92).

Therefore, it can be said that by limiting A2 to a value within a predetermined range, the value of A2−A1 can also be accurately controlled to be within a predetermined range.

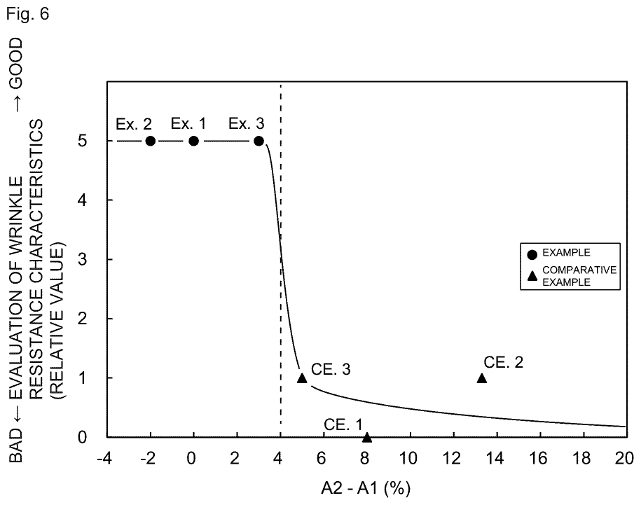

Next, referring to FIG. 6, the relationship between the difference between predetermined thermal shrinkage ratios (A2−A1) and the rating (relative value) of the wrinkle resistance characteristics will be described.

That is, the axis of abscissa in FIG. 6 represents the value of A2−A1(%), and the axis of ordinate represents the rating (relative value) of the wrinkle resistance characteristic.

The rating (relative value) of the wrinkle resistance characteristics is numerically expressed such that the rating ⊙ obtained in Example 1 and the like is 5 points, the rating ◯ is 3 points, the rating Δ is 1 point, and the rating x is 0 points.

From the characteristic curve in FIG. 6, it is understood that when the numerical value represented by A2−A1 has a value within a range of −4% to 4%, the rating (relative value) of the wrinkle resistance characteristics is 3 or more points, and satisfactory wrinkle resistance characteristics are obtained.

Therefore, it can be said that by limiting the value of A2−A1 to a value within a range of −4% to 4%, the wrinkle resistance characteristics of the heat-shrinkable polyester film can also be accurately controlled.

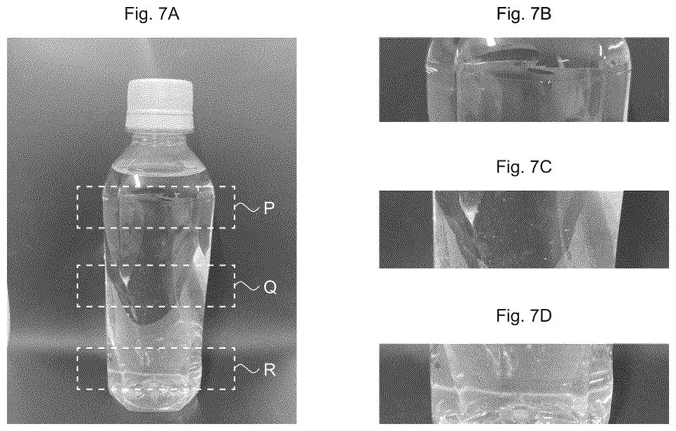

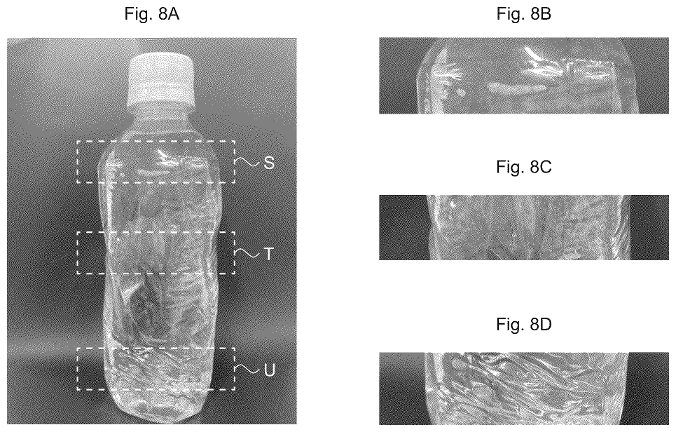

Next, referring to FIG. 7 and FIG. 8, the wrinkle resistance characteristics when a heat-shrinkable polyester film as a tubular-shaped label is wrapped around a PET bottle will be specifically described.

That is, FIG. 7 is a photograph of the appearance of a tubular-shaped label corresponding to Example 1 in a case where wrinkles do not occur, and FIG. 7A shows the entire body part of the PET bottle covered with the tubular-shaped label.

FIGS. 7B to 7D are enlarged views of the upper part (region P), middle part (region Q), and lower part (region R), respectively, of the body part shown in FIG. 7A, and it is understood that no wrinkles have occurred at all in any site of the upper part through the lower part.

On the other hand, FIG. 8 is a photograph of the appearance of a tubular shaped label corresponding to Comparative Example 1, in a case in which wrinkles have occurred, and FIG. 8A shows the entire body part of a PET bottle covered with the tubular-shaped label.

FIGS. 8B to 8D are enlarged views of the upper part (region S), middle part (region T), and lower part (region U), respectively, of the body part shown in FIG. 8A, and it is understood that wrinkles have occurred in all sites of the upper part through the lower part.

It has been separately made clear that when at least the configurations (a) to (d) of the present invention are not satisfied, with regard to a PET bottle in a case where a heat-shrinkable polyester film as a tubular-shaped label is wrapped around a PET bottle, deformation in the PET bottle itself also occurs.

### 4. Configuration (c)

Configuration (c) is a necessary configuration requirement to the effect that when the heat shrinkage ratio obtained in a case where the heat-shrinkable polyester film is shrunk in the TD direction under the conditions of 10 seconds in hot water at 80° C. is designated as A3, this A3 has a value of 30% or more.

That is, by specifically limiting such a thermal shrinkage ratio A3 to be equal to or more than a predetermined value, each of the thermal shrinkage ratios (A1, A2) before and after an aging treatment is likely to be controlled more easily to a value within a predetermined range.

More specifically, when the thermal shrinkage ratio A3 is less than 30%, each of the thermal shrinkage ratios (A1, A2) measured at 70° C. for 10 seconds before and after an aging treatment under high humidity conditions cannot be controlled to a value within a predetermined range, and the occurrence of wrinkles may not be suppressed.

Furthermore, the thermal shrinkage ratios at 80° C. to 100° C. may be insufficient, the heat-shrinkable polyester film may not be able to follow the shape of a PET bottle when the film is wrapped around the bottle, and it may not be possible to suppress the occurrence of wrinkles.

Therefore, it is more preferable that the lower limit of the thermal shrinkage ratio A3 obtained when the heat-shrinkable polyester film is shrunk in the TD direction under the conditions of 10 seconds in hot water at 80° C. as the configuration (c), has a value of 40% or more, and even more preferably a value of 45% or more.

However, when the thermal shrinkage ratio A3 is excessively large, the balance with thermal shrinkage in the MD direction may be deteriorated, and satisfactory wrinkle resistance characteristics may not be obtained at the time of thermal shrinkage of the film.

Therefore, it is preferable that the upper limit of the thermal shrinkage ratio A3 as the configuration (c) has a value of 75% or less, more preferably a value of 65% or less, and even more preferably a value of 60% or less.

### 5. Configuration (d)

Configuration (d) is a necessary configuration requirement to the effect that when the thermal shrinkage ratio obtained in a case where a shrink film is thermally shrunk in the MD direction under the conditions of 10 seconds in hot water at 90° C. is designated as B, this B has a value of 10% or less.

That is, by specifically limiting such a thermal shrinkage ratio B to be equal to or less than a predetermined ratio, the wrinkle resistance characteristics at the time of thermal shrinkage of the shrink film can be further improved.

More specifically, when the thermal shrinkage ratio B is more than 10%, the influence on A1, A2, and the like cannot be reduced, and satisfactory wrinkle resistance characteristics may not be obtained at the time of thermal shrinkage of the film.

Therefore, it is more preferable that the upper limit of the thermal shrinkage ratio B obtained when the heat-shrinkable polyester film is shrunk in the MD direction under the conditions of 10 seconds in hot water at 90° C. as the configuration (d), has a value of 8% or less, and even more preferably a value of 7% or less.

However, when the thermal shrinkage ratio B is excessively small, the balance with thermal shrinkage in the TD direction at 80° C. to 100° C. may be deteriorated, and satisfactory wrinkle resistance characteristics may not be obtained at the time of thermal shrinkage of the film.

Therefore, it is preferable that the lower limit of the thermal shrinkage ratio B as the configuration (d) has a value of 1% or more, more preferably a value of 2% or more, and even more preferably a value of 3% or more.

### 6. Optional Configuration Requirements

### (1) Configuration (e)

Configuration (e) is a configuration requirement related to the thickness (average thickness) of the heat-shrinkable polyester film of the first embodiment before thermal shrinkage, and is usually an optional configuration requirement to the effect that the thickness has a value within a range of 10 to 100 μm.

That is, by specifically limiting the thickness of the film before thermal shrinkage to a value within a predetermined range in this way, each of the thermal shrinkage ratios A1, A2, A3, and B, a numerical value represented by A1-A2, the maximum shrinkage stress C, and the like, is likely to be controlled more easily to a value within a predetermined range.

Therefore, the influence of predetermined factors is reduced, there is little variation in the thermal shrinkage ratio at a predetermined temperature, and satisfactory wrinkle resistance characteristics can be obtained.

More specifically, it is because when the thickness of the film before thermal shrinkage is less than 10 μm or more than 100 μm, non-uniform shrinkage due to rapid thermal response in the heat-shrinkable polyester film at the time of thermal shrinkage cannot be suppressed, and it may not be possible to suppress the occurrence of wrinkles.

Therefore, it is more preferable that the thickness of the film before thermal shrinkage as the configuration (e) has a value within a range of 15 to 60 μm, and even more preferably a value within a range of 20 to 40 μm.

### (2) Configuration (f)

Configuration (f) is an optional configuration requirement to the effect that the thermal shrinkage ratio obtained when the heat-shrinkable polyester film of the first embodiment is left to stand for 24 hours under high humidity conditions of 20° C. and 90% RH and then is shrunk in the TD direction under the conditions of 10 seconds in hot water at 80° C., is designated as A4(%), a numerical value represented by A4−A3 has a value of 3% or less.

That is, it is because, by limiting such a numerical value represented by A4−A3 to be equal to or less than a predetermined value, the numerical value represented by A2−A1 is also easily controlled, and the wrinkle resistance characteristics can be further improved.

Therefore, it is more preferable that the upper limit of the numerical value represented by A4−A3 as the configuration (f) has a value of 2% or less, and even more preferably a value of 1% or less.

However, even when the numerical value represented by A4−A3 is excessively small, it may be difficult to control the numerical value represented by A2−A1, and satisfactory wrinkle resistance characteristics may not be obtained.

Therefore, it is preferable that the lower limit of the numerical value represented by A4−A3 as the configuration (f) has a value of −1% or more, more preferably a value of −0.5% or more, and even more preferably a value of 0% or more.

### (3) Configuration (g)

Configuration (g) is an optional configuration requirement to the effect that with regard to the heat-shrinkable polyester film of the first embodiment, the thermal shrinkage ratio A4 has a value within a range of 30% to 70%.

That is, by limiting the thermal shrinkage ratio A4 together with the above-mentioned thermal shrinkage ratio A3 to be each within a predetermined range, the numerical value represented by A4−A3 is likely to be controlled more easily to a value within a predetermined range.

Furthermore, by controlling the numerical value represented by A4−A3, the thermal shrinkage ratio at 70° C. or 90° C. is more easily controlled to a value within a predetermined range.

More specifically, when such a thermal shrinkage ratio A4 has a value of more than 70%, it may be difficult to control the numerical value represented by A4−A3 to a value within a predetermined range.

On the other hand, when the thermal shrinkage ratio A4 has a value of less than 30%, it may be difficult to control the numerical value represented by A4−A3 to a value within a predetermined range, or it may be difficult to control the thermal shrinkage ratio at 70° C. or 90° C. to a value within a predetermined range.

Therefore, it is more preferable that the numerical value represented by A4 as the configuration (g) has a value within a range of 40% to 65%, and even more preferably a value within a range of 45% to 60%.

### (4) Configuration (h)

Configuration (h) is an optional configuration requirement to the effect that when the moisture percentages measured according to JIS K 0113:2005 before and after the heat-shrinkable polyester film of the first embodiment is left to stand for 24 hours under high humidity conditions at 20° C. and 90% RH are designated as W1 (ppm) and W2 (ppm), a numerical value represented by W2-W1 has a value of 2500 ppm or less.

That is, by limiting W2−W1 to be equal to or less than a predetermined value in this way, the hygroscopic property under predetermined high humidity conditions can be accurately suppressed, and the wrinkle resistance characteristics can be further improved.

More specifically, when the value of W2−W1 is a value of more than 2500 ppm, even when the shrink film is left to stand for a relatively short period of time, the moisture percentage in the shrink film increases, and the polyester resin may be easily hydrolysable. As a result, the average molecular weight and the intrinsic viscosity (IV) may be decreased, physical properties such as the thermal shrinkage ratio may change, and excellent wrinkle resistance characteristics may not be exhibited.

Therefore, it is more preferable that the upper limit of the numerical value represented by W2−W1 as the configuration (h) has a value of 2400 ppm or less, and even more preferably a value of 2300 ppm or less.

However, when the value of W2−W1 is excessively small, the types of the polyester resin available for use may be excessively limited, or it may be difficult to stably control the value of W2−W1, and the product yield in production may be markedly decreased. Furthermore, it may be difficult to control the numerical value represented by A2−A1 to a value within a predetermined range, and excellent wrinkle resistance characteristics may not be exhibited.

Therefore, it is preferable that the lower limit of the numerical value represented by W2−W1 as the configuration (h) has a value of 1500 ppm or more, more preferably a value of 1600 ppm or more, and even more preferably a value of 1700 ppm or more.

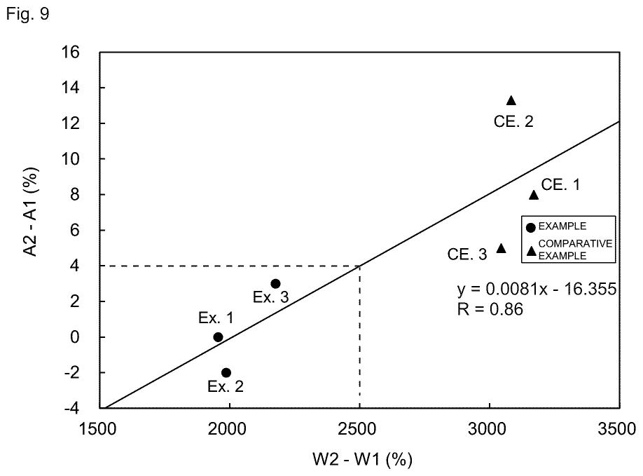

Here, referring to FIG. 9, the relationship between the difference between predetermined moisture percentages (W2−W1) and the difference between predetermined thermal shrinkage ratios (A2−A1) in a heat-shrinkable polyester film measured before and after an aging treatment will be described.

That is, the axis of abscissa in FIG. 9 represents the value of the difference between predetermined moisture percentages (W2−W1) (ppm), and the axis of ordinate represents the difference between predetermined thermal shrinkage ratios (A2−A1) (%).

From the characteristic curve in FIG. 9, it is understood that the numerical value represented by W2−W1 is 2500 ppm or less, the value of A2−A1 can be controlled to be 4% or less.

Therefore, it can be said that by limiting the difference between predetermined moisture percentages (W2−W1) in the heat-shrinkable polyester film measured before and after an aging treatment, as measured in Example 1 and the like that will be described below, it is also easy to control the difference between predetermined thermal shrinkage ratios (A2−A1).

### (5) Configuration (i)

Configuration (i) is an optional configuration requirement to the effect that with regard to the heat-shrinkable polyester film of the first embodiment, the moisture percentage W1 has a value within a range of 2000 to 3500 ppm, and the moisture percentage W2 has a value within a range of 4000 to 5500 ppm.

That is, when the moisture percentages W1 and W2 deviate from the above-mentioned values within predetermined ranges, it may be difficult to control the numerical value represented by W2−W1 to be within a predetermined range.

Therefore, it is more preferable that W1 as the configuration (i) has a value within a range of 2800 to 3200 ppm, and even more preferably a value within a range of 2900 to 3150 ppm.

It is more preferable that W2 has a value within a range of 4500 to 5400 ppm, and even more preferably a value within a range of 4800 to 5300 ppm.

### (6) Configuration (j)

Configuration (j) is an optional configuration requirement to the effect that with regard to the heat-shrinkable polyester film of the first embodiment, the maximum shrinkage stress at a shrinkage temperature of 85° C. in the TD direction is designated as C, and this C has a value of 12 MPa or less.

That is, by controlling the maximum shrinkage stress to be equal to or less than a predetermined value, wrinkles occurring due to excess maximum shrinkage stress at the time of thermal shrinkage can be effectively suppressed.

More specifically, when such maximum shrinkage stress C has a value of more than 12 MPa, the maximum shrinkage stress at the time of thermal shrinkage is excessive, and when the heat-shrinkable polyester film is wrapped around a PET bottle or the like, the shape of the PET bottle may be deformed, or wrinkles associated with the deformation may occur.

Therefore, it is more preferable that the upper limit of the maximum shrinkage stress C as the configuration (j) has a value of 10 MPa or less, and even more preferably a value of 8 MPa or less.

However, when the value of such maximum shrinkage stress C is excessively small, the maximum shrinkage stress at the time of thermal shrinkage is insufficient, and as a gap may be formed between a PET bottle and the film, wrinkles may occur.

Therefore, it is preferable that the lower limit of the maximum shrinkage stress C as the configuration (j) has a value of 2 MPa or more, more preferably a value of 3 MPa or more, and even more preferably a value of 4 MPa or more.

### (7) Configuration (k)

Configuration (k) is an optional configuration requirement to the effect that with regard to the heat-shrinkable polyester film of the first embodiment, b* in the chromaticity coordinates of CIE 1976 L*a*b* as measured according to JIS Z 8781-4:2013 has a value within a range of 0.15 to 0.3.

That is, by limiting b* in the CIE chromaticity coordinates to a value within a predetermined range in this way, the blending amount of a crystalline polyester resin and the like in the shrink film can be controlled more accurately. Therefore, at least the numerical values related to the configurations (a) to (d) in the shrink film are easily controlled to be in predetermined ranges, and the wrinkle resistance characteristics obtained when the shrink film is left to stand for a relatively short period of time under high humidity conditions, can be further improved.

More specifically, when b* in the CIE chromaticity coordinates has a value of less than 0.15, the blending amount of the crystalline polyester resin and the like in the shrink film is excessively small, and it is difficult to suppress hygroscopic property in a case where the shrink film is left to stand for a relatively short period of time in a predetermined high humidity environment. Therefore, it may be difficult to control the numerical value represented by A2−A1 to be within a predetermined range.

On the other hand, when b* in the CIE chromaticity coordinates has a value of more than 0.30, the blending amount of the crystalline polyester resin and the like in the shrink film may increase excessively, and it may be difficult to control the thermal shrinkage ratio, the maximum shrinkage stress, and the like near the shrinkage temperature to be in desired ranges.

Therefore, it is more preferable that b* in the CIE chromaticity coordinates has a value within a range of 0.17 to 0.28, and even more preferably a value within a range of 0.19 to 0.26.

### (8) Configuration (m)

Configuration (m) is an optional configuration requirement to the effect that with regard to the heat-shrinkable polyester film of the first embodiment, a haze value of the film before thermal shrinkage as measured according to JIS K 7136:2000 has a value of 8% or less.

That is, by specifically limiting the haze value to a value within a predetermined range in this way, the transparency of the heat-shrinkable polyester film is also easily controlled quantitatively, and from the viewpoint of having satisfactory transparency, versatility can be further enhanced.

More specifically, when the haze value of the film before thermal shrinkage has a value of more than 8%, transparency may be decreased, and it may be difficult to apply the film to decorative use and the like for a PET bottle.

On the other hand, when the haze value of the film before thermal shrinkage is excessively small, it may be difficult to stably control the haze value, and the product yield in production may be markedly decreased.

Therefore, it is more preferable that the haze value of the film before thermal shrinkage as the configuration (m) has a value within a range of 0.1% to 6%, and even more preferably a value within a range of 0.5% to 5%.

### (9) Others

It is preferable that various additives are blended into the heat-shrinkable polyester film of the first embodiment or into one surface or both surfaces of the film, or those various additives are attached thereto.

More specifically, it is preferable that at least one of a hydrolysis inhibitor, an antistatic agent, an ultraviolet absorber, an infrared absorber, a colorant, an organic filler, an inorganic filler, organic fibers, inorganic fibers, and the like is blended usually in an amount in a range of 0.01% to 10% by weight, and more preferably blended in an amount in a range of 0.1% to 1% by weight, with respect to the total amount of the heat-shrinkable polyester film.

As shown in FIG. 1B, it is also preferable that other resin layers 10a and 10b including at least one of these various additives are laminated on one surface or both surfaces of the heat-shrinkable polyester film 10.

In that case, when the thickness of the heat-shrinkable polyester film is taken as 100%, it is preferable that the single layer thickness or the total thickness of the other resin layers that are additionally laminated has a value usually within a range of 0.1% to 10%.

The resin as a main component constituting the other resin layers may be the same polyester resin as that of the heat-shrinkable polyester film, or it is preferable that the resin is at least one of an acrylic resin, an olefin resin, a urethane resin, a rubber resin, and the like, which are different from the polyester resin.

In addition, it is also preferable that the heat-shrinkable polyester film has a multilayer structure to further promote a hydrolysis preventing effect or mechanical protection, or as shown in FIG. 1C, a shrinkage ratio adjusting layer 10c is provided on the surface of the heat-shrinkable polyester film 10 so that the shrinkage ratio of the heat-shrinkable polyester film is uniform in the plane.

Such a shrinkage ratio adjusting layer can be laminated by using an adhesive, a coating method, a heating treatment, or the like depending on the shrinkage characteristics of the heat-shrinkable polyester film.

More specifically, the thickness of the shrinkage ratio adjusting layer is in a range of 0.1 to 3 μm, and when the shrinkage ratio of the heat-shrinkable polyester film at a predetermined temperature is excessively large, it is preferable to laminate a shrinkage ratio adjusting layer of a type that suppresses the large shrinkage ratio.

Furthermore, when the shrinkage ratio of the heat-shrinkable polyester film at a predetermined temperature is excessively small, it is preferable to laminate a shrinkage ratio adjusting layer of a type that increases the small shrinkage ratio.

Therefore, it is intended to obtain a desired shrinkage ratio by using a shrinkage ratio adjusting layer without producing various shrink films having different shrinkage ratios as the heat-shrinkable polyester film.

### Second Embodiment

A second embodiment is an embodiment related to a method for producing the heat-shrinkable polyester film of the first embodiment.

### 1. Raw Material Preparation and Mixing Step

First, it is preferable to prepare main agents and additives, such as a crystalline polyester resin, a non-crystalline polyester resin, a rubber resin, an antistatic agent, and a hydrolysis inhibitor, as raw materials.

Next, it is preferable that the prepared crystalline polyester resin, non-crystalline polyester resin, and the like are introduced into a stirring vessel while being weighed, and the raw materials are mixed and stirred using a stirring device until the mixture becomes uniform.

### 2. Original Sheet Production Step

Next, it is preferable that the uniformly mixed raw materials are dried into an absolutely dry state.

Next, typically, it is preferable to perform extrusion molding and produce an original sheet before stretching (sometimes simply referred to original sheet) having a predetermined thickness.

More specifically, for example, extrusion molding is performed by using an extruder (manufactured by Tanabe Plastics Machinery Co., Ltd.) with L/D 24 and an extrusion screw diameter of 50 mm under the conditions of an extrusion temperature of 245° C., and an original sheet having a predetermined thickness (usually, 30 to 1000 μm) can be obtained.

### 3. Production of Heat-Shrinkable Polyester Film

Next, the obtained original sheet is heated and pressed while being moved on rolls and between rolls by using a shrink film production apparatus to produce a heat-shrinkable polyester film.

That is, it is preferable that polyester molecules constituting the heat-shrinkable polyester film are crystallized into a predetermined shape by stretching the original sheet in a predetermined direction while heating and pressing the film while basically extending the film width at a predetermined preliminary heating temperature, stretching temperature, thermal fixation temperature, and the stretch ratio that will be described below.

Then, by solidifying the resultant in that state, a heat-shrinkable polyester film that is used as decorations, labels, and the like can be produced.

### (1) Stretch Ratio in MD Direction

It is preferable that the stretch ratio in the MD direction (average MD direction stretch ratio, may be simply referred to as MD direction stretch ratio) of the heat-shrinkable polyester film before thermal shrinkage has a value within a range of 100% to 200%.

The reason for this is that by specifically limiting the MD direction stretch ratio to a value within a predetermined range in this way and specifically limiting each of the thermal shrinkage ratios A1, A2, and B, the numerical value represented by A2−A1, the moisture percentages W1 and W2, the numerical value represented by W2−W1, the maximum shrinkage stress C, and the like to a value within a predetermined range, a heat-shrinkable polyester film that has little variation in the thermal shrinkage ratio at a predetermined temperature even after being left to stand under high humidity conditions and under the conditions of a predetermined time and has satisfactory wrinkle resistance characteristics, can be obtained.

More specifically, it is because when the MD direction stretch ratio has a value of less than 100%, the product yield in production may be markedly decreased.

On the other hand, it is because when the MD direction stretch ratio is more than 200%, the shrinkage ratio in the TD direction is affected, and adjustment of the shrinkage ratio itself may be difficult.

Therefore, it is more preferable that the MD direction stretch ratio has a value within a range of 110% to 180%, and even more preferably a value within a range of 120% to 160%.

### (2) Stretch Ratio in TD Direction

Furthermore, it is a suitable embodiment that the stretch ratio in the TD direction (average TD direction stretch ratio, may be simply referred to as TD direction stretch ratio) of the heat-shrinkable polyester film before thermal shrinkage has a value within a range of 300% to 600%.

The reason for this is that by specifically limiting not only the above-mentioned MD direction stretch ratio but also the TD direction stretch ratio to values within predetermined ranges, and specifically limiting each of the thermal shrinkage ratios A1, A2, and B, the numerical value represented by A2−A1, the moisture percentages W1 and W2, the numerical value represented by W2−W1, the maximum shrinkage stress C, and the like to a value within a predetermined range, a heat-shrinkable polyester film that has little variation in the thermal shrinkage ratios at a predetermined temperature even after being left to stand under high humidity conditions and under the conditions of a predetermined time and has satisfactory wrinkle resistance characteristics, can be obtained.

More specifically, it is because when the TD direction stretch ratio has a value of less than 300%, the shrinkage ratio in the TD direction may be markedly decreased, and the use applications of the heat-shrinkable polyester film available for use may be excessively limited.

On the other hand, it is because when the TD direction stretch ratio has a value of more than 600%, the thermal shrinkage ratio may be markedly increased, and the use applications of the heat-shrinkable polyester film available for use may be excessively limited, or it may be difficult to control the stretch ratio itself to be constant.

Therefore, it is more preferable that the TD direction stretch ratio has a value within a range of 350% to 550%, and even more preferably a value within a range of 400% to 500%.

### 4. Heat-Shrinkable Polyester Film Inspection Step

It is preferable that the following characteristics and the like are measured continuously or intermittently for the produced heat-shrinkable polyester film, and a predetermined inspection step is provided.

That is, by measuring the following characteristics and the like by a predetermined inspection step and checking whether the values fall within predetermined ranges, a heat-shrinkable polyester film having more uniform shrinkage characteristics and the like can be obtained.
1) Examination by visual inspection on the appearance of the heat-shrinkable polyester film
2) Measurement of variation in thickness
3) Measurement of tensile modulus of elasticity
4) Measurement of tear strength
5) Measurement of viscoelasticity characteristics using an SS curve

For the production of the heat-shrinkable polyester film of the second embodiment, it is important to measure the following configurations (a) to (d) and check that the configurations have values within predetermined ranges.
(a) When thermal shrinkage ratios obtained in a case where the heat-shrinkable polyester film is shrunk in the TD direction under the conditions of 10 seconds in hot water at 70° C. before and after being left to stand for 24 hours under high humidity conditions at 20° C. and 90% RH, are designated as A1(%) and A2(%), respectively, the thermal shrinkage ratio A1 has a value within a range of 0% to 20%, and the thermal shrinkage ratio A2 has a value within a range of 0% to 24%.
(b) A numerical value represented by A2−A1, which is a difference between the thermal shrinkage ratio A1 and the thermal shrinkage ratio A2, has a value within a range of −4% to 4%.
(c) When a thermal shrinkage ratio obtained in a case where the heat-shrinkable polyester film is shrunk in the TD direction under the conditions of 10 seconds in hot water at 80° C. is designated as A3, this A3 has a value of 30% or more.
(d) When a thermal shrinkage ratio obtained in a case where the heat-shrinkable polyester film is shrunk in the MD direction under the conditions of 10 seconds in hot water at 90° C. is designated as B, this B has a value of 10% or less.

### Third Embodiment

A third embodiment is an embodiment related to a method of using a heat-shrinkable polyester film.

Therefore, that is, known methods of using shrink films can all be suitably applied.

For example, upon carrying out a method of using a heat-shrinkable polyester film, first, the heat-shrinkable polyester film is cut into an appropriate length or width, and at the same time, a long tubular-shaped object is formed.

Next, this long tubular-shaped object is supplied to an automatic label wrapping apparatus (shrink labeler) and further cut into a required length.

Next, the long tubular-shaped object is fitted onto a PET bottle filled with contents.

Next, as a heating treatment for the heat-shrinkable polyester film fitted onto a PET bottle or the like, the PET bottle or the like is passed through the inside of a hot air tunnel or a steam tunnel at a predetermined temperature.

Then, by blowing radiant heat such as infrared radiation or heated steam at about 90° C. provided in these tunnels from the surroundings, the heat-shrinkable polyester film is uniformly heated and thermally shrunk.

Therefore, a labeled container can be quickly obtained by closely attaching the heat-shrinkable polyester film to the outer surface of the PET bottle or the like.

Here, according to the heat-shrinkable polyester film of the present invention, as described above in the first embodiment, there is provided a heat-shrinkable polyester film derived from a polyester resin composition including a crystalline polyester resin in an amount in a range of 10% to 50% by weight with respect to the total resin amount, the heat-shrinkable polyester film satisfying at least configurations (a) to (d).

In that way, even when the heat-shrinkable polyester film is left to stand for a relatively short period of time under high humidity conditions, changes in physical properties associated with moisture absorption can be prevented, and predetermined thermal shrinkage ratios can be obtained with satisfactory reproducibility at each heat treatment temperature.

Therefore, even when the values of the thermal shrinkage ratios and the like vary to some extent, predetermined influencing factors can be reduced, non-uniform shrinkage caused by rapid thermal response in the heat-shrinkable polyester film at the time of thermal shrinkage can be suppressed, and as a result, the occurrence of fine wrinkles can also be suppressed.

Therefore, as shown in FIGS. 7A to 7D, even when a label made from the shrink film is placed over the body part of a bottle and thermally shrunk, the label can be wrapped around by following the shape around the bottle, and the occurrence of fine wrinkles can also be suppressed.

On the other hand, when the heat-shrinkable polyester film does not satisfy at least the configurations (a) to (d), as shown in FIGS. 8A to 8D, non-uniform shrinkage of the shrink film occurs in the upper part through the lower part of the body part of the bottle, and the occurrence of wrinkles is notably observed.

### EXAMPLES

Hereinafter, the present invention will be described in detail on the basis of Examples. However, the scope of rights of the present invention is not to be limited by the description of Examples and the like, without any particular reason.

The polyester resins and the like used in the Examples and the like are as follows.

### (PETG1)

A non-crystalline polyester composed of dicarboxylic acid: 100 mol % of terephthalic acid, diol: 70 mol % of ethylene glycol, 28 mol % of neopentyl glycol, and 2 mol % of diethylene glycol

### (PETG2)

A non-crystalline polyester composed of dicarboxylic acid: 100 mol % of terephthalic acid, diol: 68 mol % of ethylene glycol, 22 mol % of 1, 4-cyclohexanedimethanol, and 10 mol % of diethylene glycol

### (PETG3)

A non-crystalline polyester composed of dicarboxylic acid: 100 mol % of terephthalic acid, diol: 66 mol % of ethylene glycol, 22 mol % of 1, 4-cyclohexanedimethanol, and 12 mol % of diethylene glycol

### (APET)

A crystalline polyester composed of dicarboxylic acid: 100 mol % of terephthalic acid, diol: 100 mol % of ethylene glycol

### (PCR)

A crystalline polyester resin, which is a recycled polyester resin (PCR), composed of dicarboxylic acid: 98.6 mol % of terephthalic acid, 1.4 mol % of isophthalic acid, diol: 97.3 mol % of ethylene glycol, and 2.7 mol % of diethylene glycol

### (PBT)

A crystalline polyester composed of dicarboxylic acid: 100 mol % of terephthalic acid, diol: 100 mol % of 1,4-butanediol

### (Additive (Anti-Blocking Agent))

A silica masterbatch composed of matrix resin: PET, silica content: 5% by mass, average particle size of silica: 2.7 μm

### Example 1

### 1. Production of Heat-Shrinkable Polyester Film

65 parts by weight (pbw) of a non-crystalline polyester resin (PETG1), 25 parts by weight of a crystalline polyester resin (A-PET), 10 parts by weight of a different crystalline polyester resin (PBT), and 1 part by weight of a predetermined additive (anti-blocking agent) were placed in a stirring vessel.

Next, these raw materials were brought into an absolutely dry state, subsequently extrusion molding was performed by using an extruder (manufactured by Tanabe Plastics Machinery Co., Ltd.) with L/D 24 and an extrusion screw diameter of 50 mm under the conditions of an extrusion temperature of 245° C., and an original sheet having a thickness of 150 μm was obtained.

Next, a heat-shrinkable polyester film having a thickness of 30 μm was produced from the original sheet by using a shrink film production apparatus at a preliminary heating temperature of 87° C., a stretching temperature of 88° C., a thermal fixation temperature of 85° C., and stretch ratios (MD direction: 120%, TD direction: 450%).

### 2. Evaluation of Heat-Shrinkable Polyester Film

### (1) Evaluation 1: Variation in Thickness

The thickness (taking the desired value 30 μm as a reference value) of the obtained heat-shrinkable polyester film was measured by using a micrometer and was evaluated according to the following criteria as Eva 1.
⊙ (Very good): The variation in thickness is a value within a range of (reference value±0.1 μm).
◯ (Good): The variation in thickness is a value within a range of (reference value±0.5 μm).
Δ (Fair): The variation in thickness is a value within a range of (reference value±1.0 μm).
x (Bad): The variation in thickness is a value within a range of (reference value±3.0 μm).

### (2) Evaluation 2: Thermal Shrinkage Ratios (A1 and A2)

Before and after the obtained heat-shrinkable polyester film was left to stand for 24 hours under high humidity conditions of 20° C. and 90% RH, the thermal shrinkage ratios in the TD direction obtained when the heat-shrinkable polyester film was thermally shrunk under the conditions of 10 seconds in hot water at 70° C. by using a constant-temperature water bath, were measured as A1(%) and A2(%), respectively, according to the following Formula (1).

Furthermore, the value of A2−A1 was calculated from the obtained thermal shrinkage ratios A1 and A2 and was used for each evaluation as Eva 2.

$$Thermal shrinkage ratio = \frac{( \begin{matrix}Length of film before thermal shrinkage - \\ Length of film after thermal shrinkage\end{matrix} )}{Length of film before thermal shrinkage} \times 100 \qquad ( 1 )$$

### (2)-1 Evaluation 2-1: Thermal Shrinkage Ratio (A1)

The measured thermal shrinkage ratio (A1) was evaluated according to the following criteria.
⊙ (Very good): The thermal shrinkage ratio (A1) has a value of 19% or less.
◯ (Good): The thermal shrinkage ratio (A1) has a value of 20% or less.
Δ (Fair): The thermal shrinkage ratio (A1) has a value of 25% or less.
x (Bad): The thermal shrinkage ratio (A1) has a value of more than 25%.

### (2)-2 Evaluation 2-2: Thermal Shrinkage Ratio (A2)

The measured thermal shrinkage ratio (A2) was evaluated according to the following criteria.
⊙ (Very good): The thermal shrinkage ratio (A2) has a value of 22% or less.
◯ (Good): The thermal shrinkage ratio (A2) has a value of 24% or less.
Δ (Fair): The thermal shrinkage ratio (A2) has a value of 30% or less.
x (Bad): The thermal shrinkage ratio (A2) has a value of more than 30%.

### (2)-3 Evaluation 2-3: Difference Between Thermal Shrinkage Ratios (A2−A1)

The calculated value of A2−A1 was evaluated according to the following criteria.
⊙ (Very good): The difference between the thermal shrinkage ratios (A2−A1) has a value within a range of −3% to 3%.
◯ (Good): The difference between the thermal shrinkage ratios (A2−A1) is outside the above-described range and has a value within a range of −4% to 4%.
Δ (Fair): The difference between the thermal shrinkage ratios (A2−A1) is outside the above-described range and has a value within a range of −8% to 8%.
x (Bad): The difference between the thermal shrinkage ratios (A2−A1) has a value of less than-8% or more than 8%.

### (3) Evaluation 3: Thermal Shrinkage Ratios (A3 and A4)

Before and after the obtained heat-shrinkable polyester film was left to stand for 24 hours under high humidity conditions of 20° C. and 90% RH, the thermal shrinkage ratios in the TD direction obtained when the heat-shrinkable polyester film was thermally shrunk under the conditions of 10 seconds in hot water at 80° C. by using a constant-temperature water bath, were measured as A3(%) and A4(%), respectively, according to the above-described Formula (1).

Furthermore, the value of A4−A3 was calculated from the obtained thermal shrinkage ratios A3 and A4 and was used for each evaluation as Eva 3.

### (3)-1 Evaluation 3-1: Thermal Shrinkage Ratio (A3)

The measured thermal shrinkage ratio (A3) was evaluated according to the following criteria.
⊙ (Very good): The thermal shrinkage ratio (A3) has a value within a range of 40% to 65%.
◯ (Good): The thermal shrinkage ratio (A3) is outside the above-described range and has a value within a range of 30% to 70%.
Δ (Fair): The thermal shrinkage ratio (A3) is outside the above-described range and has a value within a range of 25% to 75%.
x (Bad): The thermal shrinkage ratio (A3) has a value of less than 25% or more than 75%.

### (3)-2 Evaluation 3-2: Thermal Shrinkage Ratio (A4)

The measured thermal shrinkage ratio (A4) was evaluated according to the following criteria.
⊙ (Very good): The thermal shrinkage ratio (A4) has a value of 40% to 65%.
◯ (Good): The thermal shrinkage ratio (A4) is outside the above-described range and has a value within a range of 30% to 70%.
Δ (Fair): The thermal shrinkage ratio (A4) is outside the above-described range and has a value within a range of 25% to 75%.
x (Bad): The thermal shrinkage ratio (A4) has a value of less than 25% or more than 75%.

### (3)-3 Evaluation 3-3: Difference Between Thermal Shrinkage Ratios (A4−A3)

The calculated value of A4−A3 was evaluated according to the following criteria.
(Very good): The difference between the thermal shrinkage ratios (A4−A3) has a value of 2% or less.
◯ (Good): The difference between the thermal shrinkage ratios (A4−A3) has a value of 3% or less.
Δ (Fair): The difference between the thermal shrinkage ratios (A4−A3) has a value of 5% or less.
x (Bad): The difference between the thermal shrinkage ratios (A4−A3) has a value of more than 5%.

### (4) Evaluation 4: Thermal Shrinkage Ratio (B)

The obtained heat-shrinkable polyester film (MD direction) was immersed in hot water at 90° C. for 10 seconds by using a constant-temperature water bath and was thermally shrunk.

Next, the thermal shrinkage ratio (B) was measured according to the above-described Formula (1) from the dimensional changes occurred before and after a heating treatment at a predetermined temperature (hot water at 90° C.) and was evaluated according to the following criteria as Eva 4.
⊙ (Very good): The thermal shrinkage ratio (B) has a value of 8% or less.
◯ (Good): The thermal shrinkage ratio (B) has a value of 10% or less.
Δ (Fair): The thermal shrinkage ratio (B) has a value of 12% or less.
x (Bad): The thermal shrinkage ratio (B) has a value of more than 12%.

### (5) Evaluation 5: Moisture Percentages (W1 and W2)

The moisture percentages measured according to JIS K 0113:2005 obtained before and after the obtained heat-shrinkable polyester film was left to stand for 24 hours under high humidity conditions of 20° C. and 90% RH, were designated as W1 (ppm) and W2 (ppm), respectively, and the moisture percentages (moisture content percentages) were measured by a Karl Fischer coulometric titration method by using a Karl Fischer moisture meter (manufactured by Kyoto Electronics Manufacturing Co., Ltd., product name “MKC-700”).

Furthermore, the value W2−W1 was calculated from the obtained moisture percentages W1 and W2 and was used for each evaluation as Eva 5.

### (5)-1 Evaluation 5-1: Moisture Percentage (W1)

The measured moisture percentage (W1) was evaluated according to the following criteria.
⊙ (Very good): The moisture percentage (W1) has a value within a range of 2800 to 3200 ppm.
◯ (Good): The moisture percentage (W1) is outside the above-described range and has a value within a range of 2000 to 3500 ppm.
Δ (Fair): The moisture percentage (W1) is outside the above-described range and has a value within a range of 1500 to 4000 ppm.
x (Bad): The moisture percentage (W1) has a value of less than 1500 ppm or more than 4000 ppm.

### (5)-2 Evaluation 5-2: Moisture Percentage (W2)

The measured moisture percentage (W2) was evaluated according to the following criteria.
⊙ (Very good): The moisture percentage (W2) has a value within a range of 4500 to 5400 ppm.
◯ (Good): The moisture percentage (W2) is outside the above-described range and has a value within a range of 4000 to 5500 ppm.
Δ (Fair): The moisture percentage (W2) is outside the above-described range and has a value within a range of 3000 to 6000 ppm.
x (Bad): The moisture percentage (W2) has a value of less than 3000 ppm or more than 6000 ppm.

### (5)-3 Evaluation 5-3: Difference Between Moisture Percentages (W2−W1)

The calculated difference between the moisture percentages, W2−W1, was evaluated according to the following criteria.
⊙ (Very good): The difference between the moisture percentages (W2−W1) has a value of 2400 ppm or less.
◯ (Good): The difference between the moisture percentages (W2−W1) has a value of 2500 ppm or less. Δ (Fair): The difference between the moisture percentages (W2−W1) has a value of 3000 ppm or less.
x (Bad): The difference between the moisture percentages (W2−W1) has a value of more than 3000 ppm.

### (6) Evaluation 6: Maximum Shrinkage Stress (C)

The obtained heat-shrinkable polyester film was cut into a strip form having a width in the MD direction of 25.4 mm and a length in the TD direction of 75 mm, and this strip form was used as a test piece.

Next, the shrinkage stress of the test piece was measured by using a strength and elongation measuring apparatus equipped with a heating furnace.

More specifically, the heating furnace was heated in advance to 85° C., air blowing into the heating furnace was temporarily stopped, the door of the heating furnace was opened, the test piece was attached to a chuck of the strength and elongation measuring apparatus, the door of the heating furnace was quickly closed, and air blowing was restarted.

Next, the shrinkage stress was measured for 30 seconds or more, and the maximum value obtained during the measurement was designated as maximum shrinkage stress C and was evaluated according to the following criteria as Eva 6.
⊙ (Very good): The maximum shrinkage stress (C) has a value of 10 MPa or less.
◯ (Good): The maximum shrinkage stress (C) has a value of 12 MPa or less.
(Fair): The maximum shrinkage stress (C) has a value of 14 MPa or less.
x (Bad): The maximum shrinkage stress (C) has a value of more than 14 MPa.

### (7) Evaluation 7: b* in Chromaticity Coordinates

With regard to the obtained heat-shrinkable polyester film, the value of b* in the chromaticity coordinates of CIE 1976 L*a*b* as measured according to JIS Z 8781-4:2013 was measured by using a spectrophotometer (manufactured by SHIMADZU CORPORATION, product name “UV-3600”) and was evaluated according to the following criteria as Eva 7.
⊙ (Very good): The value of b* in the chromaticity coordinates is a value within a range of 0.17 to 0.28.
◯ (Good): The value of b* in the chromaticity coordinates is outside the above-described range and is a value within a range of 0.15 to 0.3.
Δ (Fair): The value of b* in the chromaticity coordinates is outside the above-described range and is a value within a range of 0.1 to 0.35.
x (Bad): The value of b* in the chromaticity coordinates is a value of less than 0.1 or more than 0.35.

### (8) Evaluation 8: Wrinkle Resistance Characteristics

A cylindrical-shaped PET bottle (volume: 500 ml) in a state of being filled with a commercially available beverage was prepared. Next, a long-shaped shrink film obtained by slitting a heat-shrinkable polyester film into a width of 26 cm was provided with perforations having a width of 1 mm along the longitudinal direction, and 1, 3-dioxolane was applied at the end parts in the width direction.

Next, the end parts in the width direction were superposed and adhered such that the overlap margin was about 1 cm, and a tubular-shaped label having a diameter of about 8 cm was obtained. Furthermore, this tubular-shaped label was cut out every 16 cm in the longitudinal direction, and a plurality of tubular-shaped labels were obtained.

Next, the body part of the prepared cylindrical-shaped PET bottle was covered with the tubular-shaped label, the PET bottle was placed on a belt conveyor and moved at a passing speed of 6 m/min through the inside of a steam tunnel maintained at 85° C., and the tubular-shaped label was thermally shrunk so as to closely adhere to the body part of the cylindrical-shaped PET bottle from the upper part through the lower part.

Finally, the tubular-shaped label after thermal shrinkage was observed by visual inspection, and by checking whether wrinkles having a predetermined length (1 cm or more) or a predetermined width (1 mm or more) had occurred, the wrinkle resistance characteristics were evaluated according to the following criteria as Eva 8.
⊙ (Very good): The occurrence of predetermined wrinkles was not observed in all five of the five tubular-shaped labels.
◯ (Good): The occurrence of predetermined wrinkles was not observed in three or more of the five tubular-shaped labels.
Δ (Fair): The occurrence of predetermined wrinkles was not observed in one or more of the five tubular-shaped labels.
x (Bad): The occurrence of predetermined wrinkles was observed in all five of the five tubular-shaped labels.

### Example 2

In Example 2, as shown in Table 1, 70 parts by weight of a non-crystalline polyester resin (PETG2) of a different type from that of Example 1, 30 parts by weight of a recycled polyester resin (PCR) as a crystalline polyester resin, and 0.8 parts by weight of the predetermined additive (anti-blocking agent) were used in order to change the values of the configurations (a) to (d) and the like.

At the same time, similarly to Example 1, a heat-shrinkable polyester film having a thickness of 30 μm was produced from the original sheet at a preliminary heating temperature of 86° C., a stretching temperature of 84° C., a thermal fixation temperature of 82° C. and at stretch ratios (MD direction: 125%, TD direction: 480%).

Then, with regard to the produced heat-shrinkable polyester film, the wrinkle resistance characteristics and the like were evaluated in the same manner as in Example 1. The results are shown in Table 2.

### Example 3

In Example 3, as shown in Table 1, 70 parts by weight of a non-crystalline polyester resin (PETG3) of a different type from that of Example 1, 30 parts by weight of a recycled polyester resin (PCR) as a crystalline polyester resin, and 0.8 parts by weight of the predetermined additive (anti-blocking agent) were used in order to change the values of the configurations (a) to (d) and the like.

At the same time, similarly to Example 1, a heat-shrinkable polyester film having a thickness of 30 μm was produced from the original sheet at a preliminary heating temperature of 85° C., a stretching temperature of 80° C., a thermal fixation temperature of 80° C., and stretch ratios (MD direction: 120%, TD direction: 480%).

Then, with regard to the produced heat-shrinkable polyester film, the wrinkle resistance characteristics and the like were evaluated in the same manner as in Example 1. The results are shown in Table 2.

### Comparative Example 1

In Comparative Example 1, as shown in Table 1, a heat-shrinkable polyester film that did not satisfy the configuration requirements (a) and (b) was produced and evaluated in the same manner as in Example 1, and the results are shown in Table 2.

That is, 90 parts by weight of a non-crystalline polyester resin (PETG2), 10 parts by weight of a crystalline polyester resin (PBT), and 0.8 parts by weight of the predetermined additive (anti-blocking agent) were used.

At the same time, a heat-shrinkable polyester film having a thickness of 30 μm was produced from the original sheet at a preliminary heating temperature of 90° C., a stretching temperature of 83° C., a thermal fixation temperature of 81° C., and stretch ratios (MD direction: 105%, TD direction: 480%).

Then, with regard to the produced heat-shrinkable polyester film, the wrinkle resistance characteristics and the like were evaluated in the same manner as in Example 1. The results are shown in Table 2.

### Comparative Example 2

In Comparative Example 2, as shown in Table 1, a heat-shrinkable polyester film that did not satisfy the configuration requirement (b) was produced, namely, a heat-shrinkable polyester film was produced and evaluated in the same manner as in Example 1, and the results are shown in Table 2.

That is, 60 parts by weight of a non-crystalline polyester resin (PETG1), 40 parts by weight of a different non-crystalline polyester resin (PETG3), and 1 part by weight of the predetermined additive (anti-blocking agent) were used.

At the same time, a heat-shrinkable polyester film having a thickness of 30 μm was produced from the original sheet at a preliminary heating temperature of 120° C., a stretching temperature of 80° C., a thermal fixation temperature of 86.5° C., and stretch ratios (MD direction: 105%, TD direction: 480%).

Then, with regard to the produced heat-shrinkable polyester film, the wrinkle resistance characteristics and the like were evaluated in the same manner as in Example 1. The results are shown in Table 2.

### Comparative Example 3

In Comparative Example 3, as shown in Table 1, a heat-shrinkable polyester film that did not satisfy the configuration requirements (a) and (b) was produced, namely, a heat-shrinkable polyester film was produced and evaluated in the same manner as in Example 1, and the results are shown in Table 2.

That is, 100 parts by weight of a non-crystalline polyester resin (PETG2) and 0.8 parts by weight of the predetermined additive (anti-blocking agent) were used.

At the same time, a heat-shrinkable polyester film having a thickness of 30 μm was produced from the original sheet at a preliminary heating temperature of 90° C., a stretching temperature of 83° C., a thermal fixation temperature of 81° C., and stretch ratios (MD direction: 105%, TD direction: 480%).

Then, with regard to the produced heat-shrinkable polyester film, the wrinkle resistance characteristics and the like were evaluated in the same manner as in Example 1. The results are shown in Table 2.

TABLE 1

| | | | | | | | | | | | MD | TD |
|---|---|---|---|---|---|---|---|---|---|---|---|---|
| | | | | | | | | Preliminary | | Thermal | direction | direction |
| | | | | | | | | heating | Stretching | fixation | stretch | stretch |
| | PETG1 | PETG2 | PETG3 | APET | PCR | PBT | Additive | temperature | temperature | temperature | ratio | ratio |
| | (pbw) | (pbw) | (pbw) | (pbw) | (pbw) | (pbw) | (pbw) | (° C.) | (° C.) | (° C.) | (%) | (%) |
| Example 1 | 65 | | | 25 | | 10 | 1 | 87 | 88 | 85 | 120 | 450 |
| Example 2 | | 70 | | | 30 | | 0.8 | 86 | 84 | 82 | 125 | 480 |
| Example 3 | | | 70 | | 30 | | 0.8 | 85 | 80 | 80 | 120 | 480 |
| Comparative | | 90 | | | | 10 | 0.8 | 90 | 83 | 81 | 105 | 480 |
| Example 1 | | | | | | | | | | | | |
| Comparative | 60 | | 40 | | | | 1 | 120 | 80 | 86.5 | 105 | 480 |
| Example 2 | | | | | | | | | | | | |
| Comparative | | 100 | | | | | 0.8 | 90 | 83 | 81 | 105 | 480 |
| Example 3 | | | | | | | | | | | | |

TABLE 2

| | Configuration | | | | | | | | | | | | | |
|---|---|---|---|---|---|---|---|---|---|---|---|---|---|---|
| | | | (b) | | | (f) | | (h) | | | | | (m) | |
| | (a) | | A2 − | (c) | (d) | A4 − | (g) | W2 − | (i) | | (j) | (k) | Haze | |
| | A1 | A2 | A1 | A3 | B | A3 | A4 | W1 | W1 | W2 | C | b* | value | |
| | (%) | (%) | (%) | (%) | (%) | (% ) | (%) | (ppm) | (ppm) | (ppm) | (MPa) | (—) | (%) | Eva 1 |
| Example 1 | 3 | 3 | 0 | 46.5 | 5.5 | 1.5 | 48 | 1956 | 3127 | 5083 | 5.1 | 0.20 | 4.5 | ⊙ |
| Example 2 | 12 | 10 | −2 | 50 | 4.5 | 0 | 50 | 1987 | 2984 | 4971 | 11.7 | 0.21 | 4.6 | ⊙ |
| Example 3 | 19 | 22 | 3 | 55 | 6.5 | 1 | 56 | 2177 | 3088 | 5265 | 11.5 | 0.21 | 4.6 | ⊙ |
| Comparative | 27 | 35 | 8 | 52 | 1.3 | 1 | 53 | 3170 | 2589 | 5759 | 5.4 | 0.13 | 3.5 | ⊙ |
| Example 1 | | | | | | | | | | | | | | |
| Comparative | 6 | 19.3 | 13.3 | 56 | 4 | 2 | 58 | 3083 | 2747 | 5830 | 16.9 | 0.09 | 4.2 | ⊙ |
| Example 2 | | | | | | | | | | | | | | |
| Comparative | 22 | 27 | 5 | 50 | 1.7 | 2 | 52 | 3045 | 2612 | 5657 | 6.9 | 0.10 | 3.6 | ⊙ |
| Example 3 | | | | | | | | | | | | | | |

| | Eva 2 | | | Eva 3 | | | | Eva 5 | | | | | |
|---|---|---|---|---|---|---|---|---|---|---|---|---|---|
| | 2-1 | 2-2 | 2-3 | 3-1 | 3-2 | 3-3 | Eva 4 | 5-1 | 5-2 | 5-3 | Eva 6 | Eva 7 | Eva 8 |
| Example 1 | ⊙ | ⊙ | ⊙ | ⊙ | ⊙ | ⊙ | ⊙ | ⊙ | ⊙ | ⊙ | ⊙ | ⊙ | ⊙ |
| Example 2 | ⊙ | ⊙ | ⊙ | ⊙ | ⊙ | ⊙ | ⊙ | ⊙ | ⊙ | ⊙ | ◯ | ⊙ | ⊙ |
| Example 3 | ⊙ | ⊙ | ⊙ | ⊙ | ⊙ | ⊙ | ⊙ | ⊙ | ⊙ | ⊙ | ◯ | ⊙ | ⊙ |
| Comparative | X | X | Δ | ⊙ | ⊙ | ⊙ | ⊙ | ◯ | Δ | X | ⊙ | Δ | X |
| Example 1 | | | | | | | | | | | | | |
| Comparative | ⊙ | ⊙ | X | ⊙ | ⊙ | ⊙ | ⊙ | ◯ | Δ | X | X | X | Δ |
| Example 2 | | | | | | | | | | | | | |
| Comparative | Δ | Δ | Δ | ⊙ | ⊙ | ⊙ | ⊙ | ◯ | Δ | X | ⊙ | Δ | Δ |
| Example 3 | | | | | | | | | | | | | |

*Eva 1: Variation in thickness
*Eva 2 to 4: Thermal shrinkage ratios A1 and A2, A3 and A4, B
*Eva 5: Moisture percentage
*Eva 6: Maximum shrinkage stress
*Eva 7: b* in chromaticity coordinates
*Eva 8: Wrinkle resistance characteristics

### INDUSTRIAL APPLICABILITY

According to the present invention, with regard to a heat-shrinkable polyester film derived from a polyester resin composition including a crystalline polyester resin in an amount in a range of 10% to 50% by weight with respect to the total resin amount, by satisfying at least configurations (a) to (d), even when the heat-shrinkable polyester film is left to stand for a predetermined time under predetermined high humidity conditions as simple aging, changes in physical properties associated with moisture absorption can be prevented, and predetermined thermal shrinkage ratios can be obtained stably with satisfactory reproducibility at each heat treatment temperature.

Therefore, with regard to the heat-shrinkable polyester film at the time of thermal shrinkage, non-uniform shrinkable caused by rapid thermal response can be suppressed, and as a result, the occurrence of fine wrinkles can also be suppressed.

That is, according to the heat-shrinkable polyester film of the present invention, since versatility can be remarkably enhanced by suitably applying the heat-shrinkable polyester film to various PET bottles, outer covering materials for lunch boxes and the like, it can be said that the industrial applicability of the heat-shrinkable polyester film is very high.

1. A heat-shrinkable polyester film derived from a polyester resin composition including a crystalline polyester resin in an amount in a range of 10% to 50% by weight with respect to a total resin amount,
wherein when a main shrinkage direction is designated as TD direction, and a direction orthogonally intersecting the TD direction is designated as MD direction, the heat-shrinkable polyester film satisfies the following configurations (a) to (d):
(a) when thermal shrinkage ratios obtained in a case where the heat-shrinkable polyester film is shrunk in the TD direction under the conditions of 10 seconds in hot water at 70° C. before and after being left to stand for 24 hours under high humidity conditions at 20° C. and 90% RH, are designated as A1(%) and A2(%), respectively, the thermal shrinkage ratio A1 has a value within a range of 0% to 20%, and the thermal shrinkage ratio A2 has a value within a range of 0% to 24%;
(b) a numerical value represented by A2−A1, which is a difference between the thermal shrinkage ratio A1 and the thermal shrinkage ratio A2, has a value within a range of −4% to 4%;
(c) when a thermal shrinkage ratio obtained in a case where the heat-shrinkable polyester film is shrunk in the TD direction under the conditions of 10 seconds in hot water at 80° C. is designated as A3, the A3 has a value of 30% or more; and
(d) when a thermal shrinkage ratio obtained in a case where the heat-shrinkable polyester film is shrunk in the MD direction under the conditions of 10 seconds in hot water at 90° C. is designated as B, the B has a value of 10% or less.

2. The heat-shrinkable polyester film according to claim 1, wherein when a thermal shrinkage ratio obtained in a case where the heat-shrinkable polyester film is shrunk in the TD direction under the conditions of 10 seconds in hot water at 80° C. after being left to stand for 24 hours under high humidity conditions at 20° C. and 90% RH, is designated as A4(%), a numerical value represented by A4−A3 has a value of 3% or less.

3. The heat-shrinkable polyester film according to claim 2, wherein the thermal shrinkage ratio A4 has a value within a range of 30% to 70%.

4. The heat-shrinkable polyester film according to claim 1, wherein when moisture percentages measured according to JIS K 0113:2005 before and after the heat-shrinkable polyester film is left to stand for 24 hours under high humidity conditions at 20° C. and 90% RH are designated as W1 (ppm) and W2 (ppm), respectively, a numerical value represented by W2−W1 has a value of 2500 ppm or less.

5. The heat-shrinkable polyester film according to claim 4, wherein the moisture percentage W1 has a value within a range of 2000 to 3500 ppm, and the moisture percentage W2 has a value within a range of 4000 to 5500 ppm.

6. The heat-shrinkable polyester film according to claim 1, wherein a maximum shrinkage stress in the TD direction at a shrinkage temperature of 85° C. is designated as C, and the C has a value of 12 MPa or less.

7. The heat-shrinkable polyester film according to claim 1, wherein b* in the chromaticity coordinates of CIE 1976 L*a*b* as measured according to JIS Z 8781-4:2013 has a value within a range of 0.15 to 0.3.

8. The heat-shrinkable polyester film according to claim 1, wherein a haze value of the film before thermal shrinkage as measured according to JIS K 7136:2000 has a value of 8% or less.
